(19) United States
(12) Patent Application Publication
(10) Pub. No.: US 2011/0162641 A1
(43) Pub. Date: Jul. 7, 2011

(54) Absorber, in Particular for a Solar Collector, and Method for Manufacturing the Same

(75) Inventors: Dieter Bitter, Finnentrop (DE); Andreas Rosenwirth, Enger (DE); Carsten Hanke, Bielefeld (DE); Eitel-Friedrich Hoecker, Bielefeld (DE)

(73) Assignee: SCHUECO International KG, Bielefeld (DE)

(21) Appl. No.: 12/683,763

(22) Filed: Jan. 7, 2010

(51) Int. Cl. F24J 2/24; B23P 15/26; B21D 39/03

(52) U.S. Cl. 126/661; 29/890.033; 29/428

(57) ABSTRACT

An absorber includes an absorber plate having an at least partly or entirely flat surface. At least one preferably metallic pipe, which likewise has a partly flat surface that rests against the flat surface of the absorber plate, and through which a heat transfer medium for carrying heat can flow, is disposed on the absorber plate with the aid of at least one heat-conducting plate. A method for manufacturing the absorber is characterized in that the at least one pipe and the heat-conducting plate(s) are placed on top of each other or combined. On this arrangement consisting of the at least one pipe and the at least one heat-conducting plate, the partly flat surface of the metallic pipe is then molded in a non-cutting forming work process.

### BACKGROUND AND SUMMARY OF THE INVENTION

The present invention relates to an absorber, in particular for a solar collector, and a method for manufacturing the same.

Solar collectors comprise a housing having an upper cover, preferably a glass pane, and a lower cover, preferably made of a sheet metal, and an absorber, which is disposed in the housing and is designed for converting sunlight and solar energy into heat The absorber includes an absorber plate and pipes in the form of lines for a heat transfer medium for transporting energy by carrying heat.

A solar collector of this kind is described in DE 20 2006 003 399, which discloses a so-called hybrid collector having specially designed heat-conducting plates.

Furthermore, a wide variety of absorbers for solar collectors are known from the prior art. These known absorbers usually include absorber plates, which are coated on the side that is oriented toward the sun and below which pipes are disposed for conveying a fluid, that is to say, a gas or a liquid. The pipes, which are usually made of a heat-conducting metal, in particular copper, are preferably formed as a meander (one pipe) or a so-called harp (several connected pipes).

Different processes are known from the prior art for connecting the copper pipes to the absorber plates.

It was thus attempted to use welded and soldered connections, which however necessitate pipes and absorber plates of the same material for achieving a good connection between them, and leave marks on that visible surface of the absorber plates that is oriented toward the sun. Another disadvantage of such connections is that they become entirely or partially loose as a result of thermal stresses. The loosening of these connections can occur particularly when different materials having variably high expansion coefficients are used.

It has been suggested in DE 20 2006 003 399 to hold the pipes below the absorber plate with the aid of so-called heat-conducting plates. This solution has indeed proved to be useful per se, but it requires the use of additional material and also leaves room for further optimization with respect to heat transfer from the absorber plate to the pipe.

Adhesive bonds between the plates for holding the pipes have also been described in the prior art. But the disadvantage of adhesive bonds is usually that they have a relatively low heat conductance value since the adhesive usually has an insulating effect. An additional known problem is that the bonded joints can be destroyed as a result of the varying thermal expansion of the plates and the pipes embedded therein.

The adhesive bonds known from the prior art also suffer from the shortcoming that even the pipes are glued to the plates, which can result in additional thermal stresses.

On the whole, the heat transfer from the absorber plate to the heat transfer medium via the pipes can still be improved further in the solutions suggested by the prior art described above. Furthermore, the outer side of the absorber must have a flawless appearance.

It is the object of the present invention to solve the two problems last mentioned.

According to the invention, an absorber is provided, which includes an at least partly flat absorber plate, on which at least one metallic pipe, through which a heat transfer medium for carrying heat can flow and which likewise has a partly flat surface resting against the flat surface of the absorber plate, is disposed with the aid of at least one heat-conducting plate.

By virtue of the fact that the absorber plate rests flatly, particularly directly against the pipe/s, an excellent heat transfer is achieved easily between these two elements of the absorber, without impairing the appearance of the absorber in this construction.

The flat surfaces of the at least one pipe and the absorber plate are preferably located parallel to each other.

The invention also provides for a method for manufacturing an absorber, in which the pipe and the heat-conducting plates are combined and the partly flat surface of the metallic pipe is then molded in a non-cutting forming work process on this arrangement consisting of the at least one pipe and the at least one heat-conducting plate.

This method ensures, in a particularly easy and uncomplicated manner, that the heat-conducting plate rests positively against the pipe, while the pipe is flattened in a forming process at least in certain sections or over its entire axial length.

Furthermore, the pipe rests directly against the absorber plate in the forming work step so that a precise contact of these two elements with each other is also ensured easily in a single work process.

By virtue of the fact that the pipes are enclosed over their entire circumference, it is possible to use pipes having a particularly thinner wall thickness, ranging between 0.2 and 0.5 mm, preferably 0.3 mm.

By virtue of the particularly good heat transfer, the length of the pipes can be reduced while maintaining the same effectiveness (which makes it possible to cut down on the material and costs involved).

It is possible to hold the pipes between the heat-conducting plate and the absorber plate for displacement in the longitudinal direction in order to compensate for thermal stresses.

The method of the invention also makes it possible to manufacture an absorber for such a solar collector particularly easily and cost-effectively.

The invention provides for a method in which a heat-conducting plate is connected to an absorber plate such that the round pipe, which is arranged in-between, is provided with a flat surface extending parallel to the absorber plate and the entire circumference of the pipe is in direct contact with the plates. This consequently simplifies the production of the absorber while still achieving the excellent heat transfer cited above.

The heat-conducting plate is preferably glued below the absorber plate. Additional advantageous features are suggested below that are aimed at improving the heat transfer of the adhesive layer.

Thus, the heat transfer of the adhesive bond can be improved by admixing heat-conducting substances, particularly metal splinters or metal fibers, to the adhesive.

It is also feasible to improve the heat transfer by partly arranging metal strips or a heat-conductive paste between the heat-conducting plate and the absorber plate.

Likewise, that surface of the heat-conducting plate that comes in contact with the absorber plate can be disposed at a different level, the heat-conducting plate being provided with portions of direct contact to the absorber plate that alternate with the adhesive portions.

Preferably, a plastic-bonding adhesive is used, which can be rolled on both sides with an adhesive effect, and can be applied to or rolled on individual strips of the heat-conducting plates in the method of the invention.

According to the invention, there is preferably no adhesive between the pipe and the absorber plate or between the heat-conducting plate and the pipe. The advantage of the absence of adhesive in the regions cited above is that the pipe can be displaced freely between the plates in the case of thermal elongation. This prevents stresses and damages of the components involved.

In a preferred embodiment, the heat-conducting plates taper toward the ends. This measure improves heat flow.

For cost reasons, an aluminum material is selected for the absorber plate and the heat-conducting plate in contrast to the commercially available copper pipes.

The non-cutting forming process is very preferably a pressing process, the at least one pipe, the at least one heat-conducting plate and preferably also the absorber plate being inserted together into a compression mold. Alternately, it is also easy and uncomplicated if the non-cutting forming process is a pressure-rolling process.

According to a preferred variant of the method of the invention, (a) at least one channel is initially formed in the at least one heat-conducting plate, (b) the pipe is then inserted into this channel and (c) the arrangement from step b) is covered by the absorber plate, and (d) the arrangement from step c) is then subjected to the forming process. Production as suggested by this method ensures, in particular, that the appearance of the absorber is not impaired by the manufacturing process.

It is advantageous if the channel has a larger diameter than the pipe inserted therein.

Since the copper pipes are enclosed approximately over their entire circumference, they can be designed with a thinner wall thickness considering that the absorber plate and the heat-conducting plate(s) are also used for absorbing pressure. This makes it possible to cut down on the cost of materials.

As a result of optimum heat transfer, the relative pipe length can be reduced, thus leading to further material savings.

The at least one pipe-preferably has the cross-sectional shape of a circle, the circumference of which is partly flattened, the flattened region forming the flat surface, which rests against the absorber plate, and the heat-conducting plates positively bordering the remaining circular outer circumference of the at least one pipe. Alternately, the at least one pipe can have the cross-sectional shape of an oval, the circumference of which is partly flattened, the flattened region forming the flat surface, which rests against the absorber plate, and the heat-conducting plates positively bordering the remaining oval-shaped outer circumference of the at least one pipe.

It is advantageous if strip-shaped sheet-metal pieces are initially cut to length i.e., from a sheet-metal roll for forming the heat-conducting plates, and the channel is then stamped in these sheet-metal pieces, the diameter of the channel being larger than that of the initial pipe.

According to another particularly preferred variant of the method, (a) the cut-to-length heat-conducting plates that are preferably already provided with the channel are rolled or coated with the adhesive of the invention, (b) the heat-conducting plates are inserted into a compression mold, (c) the bent copper pipe (meander or serpentine-shaped) or the copper pipes (harp-shaped) is/are then inserted into the channels of the heat-conducting plates, (d) the absorber plate is then placed on the pipes, and (e) the absorber plate is subsequently pressed onto the pipes using a smooth punch so that the pipes expand in the channels of the heat-conducting plates during the forming process.

In order to ensure particularly good heat transfer, the channels of the heat-conducting plates and the pipe diameter are configured to match each other such that the pipes almost completely fill out the intermediate space remaining finally between the absorber plate and the heat-conducting plate, and the absorber plate and the heat-conducting plate are pressed together.

A plurality of pipes and/or a plurality of heat-conducting plates and the absorber plate are particularly preferably interconnected in accordance with one or more steps of the preceding processes.

The method of the invention also ensures very short production times since preferably only one pressing process is carried out. However, it is also possible to carry out multiple pressing processes.

The channels of the heat-conducting plates and the pipe diameter are preferably configured to match each other such that the pipes almost completely fill out the intermediate space remaining finally between the absorber plate and the heat-conducting plate, and the absorber plate and the heat-conducting plate are pressed together properly.

The bent pipe ends or the pipe ends intended for additional connecting elements are preferably not stamped or flattened, thus allowing for thermal expansion in these regions and the mounting of connecting pipes.

It is likewise advantageous that meander-shaped or harp-shaped pipe structures can be produced easily from the round initial pipes. This would hardly be possible in case of pipes having flattened regions.

Wherever reference is made herein to at least one pipe, absorber plate or heat-conducting plate, this is also understood to include the possibility of designing and arranging a plurality of these elements in the manner described.

A plurality of pipes and/or a plurality of heat-conducting plates and the absorber plate are preferably interconnected in accordance with embodiments of the invention.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a side of an absorber for a solar collector that is oriented away from the sun;

FIG. 2 is a cross-section of a portion of an absorber known from the prior art;

FIG. 3 is a cross-section of a portion of an absorber according to the invention;

FIGS. 4-6 are cross-sections of portions of additional embodiments of absorbers according to the invention;

FIG. 7 is a sectional view or side view of an arrangement, which consists of an absorber plate, a pipe, and a heat-conducting plate, to be assembled according to the method of the invention;

FIGS. 8a, b; 9a, b show additional views of portions of the absorber according to the invention.

### DETAILED DESCRIPTION OF THE DRAWINGS

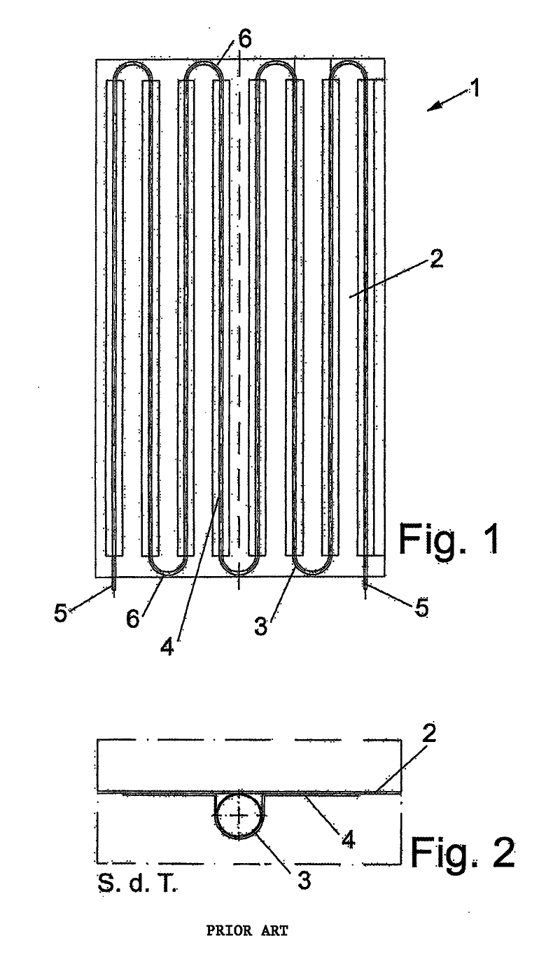

FIG. 1 is a view showing the side of an absorber for a solar collector that is oriented away from the sun; that is to say, when viewed from below when installed. The absorber 1 includes an absorber plate 2, which is preferably made of aluminum and has a coating (not illustrated here) on its surface that is oriented toward the sun for better absorption of the sun's rays. In consideration of the direction of the sunlight, at least one pipe 3 is arranged below the flat surface of the absorber plate 2, which pipe 3 is designed such that a heat transfer medium, particularly a fluid such as a gas or a liquid, can flow through the pipe for energy transport by carrying heat.

According to the exemplary embodiment of FIG. 1, the pipe 3 for the heat transfer medium is provided with a meandering or serpentine shape. This arrangement serves as an example only. Thus, several pipes could also be arranged (not shown in the Figures) e.g., in a harp-shaped form, below the absorber plate.

Commercially available metal pipes, particularly copper pipes of round cross-section, which can be bent relatively easily and to the ends 5 of which standard connecting elements can be joined, are preferably used as the initial work piece for manufacturing the absorbers. The pipe 3 is held below the absorber plate 2 with the aid of at least one heat-conducting plate, preferably a plurality of straight, profile-like heat-conducting plates 4. According to a particularly preferred embodiment, the heat-conducting plates 4 are each laid out in the form of strips, one strip-shaped heat-conducting plate being preferably assigned to each straight pipe section of the meander in the longitudinal direction, and the pipe ends 6, which are each bent around 180°, not being covered by the heat-conducting plates 4. The advantage of this arrangement is that there is no build-up of stresses in the case of thermal expansion: the pipes 3 are force-locked in such a way between the absorber plate 2 and the heat-conducting plate 4 that they allow an axial displacement. The heat-conducting plates 4 are therefore always shorter than the absorber plate 2 in their longitudinal orientation.

FIG. 2 shows a partial section of an absorber known from the prior art and including a flat absorber plate 2, below which a pipe 3 is disposed for a heat transfer medium. This pipe 3 is held by a heat-conducting plate 4. The disadvantage here is that the pipe 3 is in contact with the heat-absorbing absorber plate 2 virtually only at selected points thereof or on a line. Therefore, heat transfer between the absorber plate 2 and the pipe 3 is very poor. The heat-conducting plate 4 encloses the pipe 3 approximately around 180°; that is to say, only approximately 50% of the pipe 3 is in direct contact with the plates.

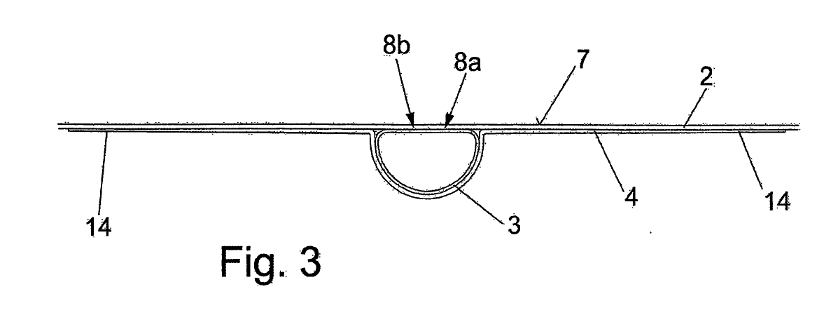

FIG. 3, just as FIG. 2, shows a partial section, this time of the absorber designed according to an embodiment of the present invention. The absorber plate 2 includes a completely flat outer surface 7 that is oriented toward the sun. This outer surface 7 is visually appealing; that is to say, its appearance is not impaired by any unevenness.

A pipe 3 (referred to as “deformed pipe section”), which is formed during the assembly of the absorber in a non-cutting forming process and which has a flat surface 8a continuously or at least partly over its axial length, is disposed below the absorber plate 2. This flat surface 8a of the pipe 3 is oriented toward the absorber plate 2 and rests directly against a corresponding flat surface 8b of the absorber plate 2. This flat surface 8a of the pipe 3 (which is preferably larger than ⅓ of the pipe circumference) is in direct contact with the absorber plate 2, thereby resulting in optimized direct heat transfer.

The heat-conducting plate 4 is glued to the absorber plate 2 and it encloses the approximately semicircular circumference of the pipe 3. As a result, heat is likewise dissipated from the absorber plate 2 via the pipe 3 to the heat transfer medium such as water, for example. It can be seen clearly that almost the entire circumference of the pipe 3 is in contact with the absorber plate 2 and the heat-conducting plate 4. There is no adhesive present between the pipe and the plates.

A pressure that is higher relative to the wall thickness of the pipe can prevail in the pipe 3 by virtue of the fact that the pipe 3 is enclosed over the entire circumference thereof. As a result, it is possible to provide the pipe wall with a very thin thickness, preferably 0.3 mm, thereby facilitating the deformation process and economizing on the material used.

An aluminum sheet having a thickness of 0.5 mm is preferably used for the absorber plate 2 and the heat-conducting plate 4, it being possible to select a special design for the heat-conducting plate 4 as described below in more detail.

The preferred adhesive bond between the absorber plate 2 and the heat-conducting plate 4 is formed such that it is particularly thin in order to achieve the best possible heat transfer despite the insulating effect of the adhesive. For further improving the heat transfer, it is suggested to admix metal splinters or metal fibers to a commercially available adhesive known per se.

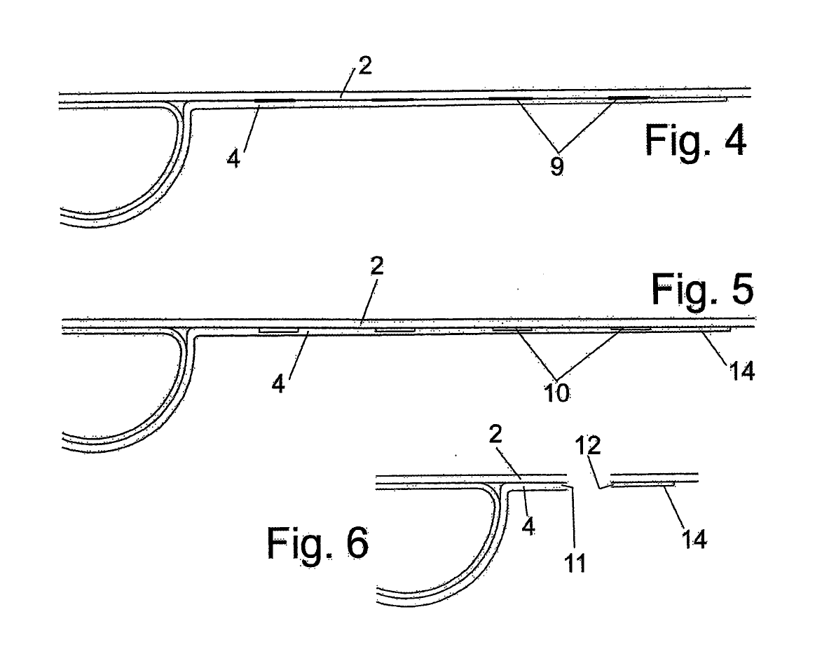

FIG. 4 shows an enlarged partial section of the absorber shown in FIG. 3, in which alternately or additionally to the metal inclusions in the adhesive, metal strips 9 or a heat-conductive paste 9 can be disposed partly between the absorber plate and the heat-conducting plate. This likewise improves heat transfer.

As another alternative, the heat-conducting plate 4, as illustrated in FIG. 5, can include chambers 10 extending in the longitudinal direction that are used for receiving the adhesive. These chambers 10 are preferably stamped during pre-production. In doing so, the number and positions of the chambers can vary, just as the width and the depth of the same. There is a direct contact between the absorber plate 2 and the heat-conducting plate 4 between the chambers.

FIG. 6 is an illustration representing the connection of the absorber plate 2 and the heat-conducting plate 4. FIG. 6 clearly shows that the heat-conducting plate 4 tapers toward its lateral ends 14. Thus it can be seen clearly that the plate thickness 11 in the vicinity of the pipe is distinctly greater than the plate thickness 12 at the lateral ends 14 of the heat-conducting plate. This conical or tapering design additionally improves the heat flow and, at the same time, economizes on the material used. The heat-conducting plate is likewise rolled in a prior work process as described above (the channel 13, the chambers 10 and the tapered ends 14).

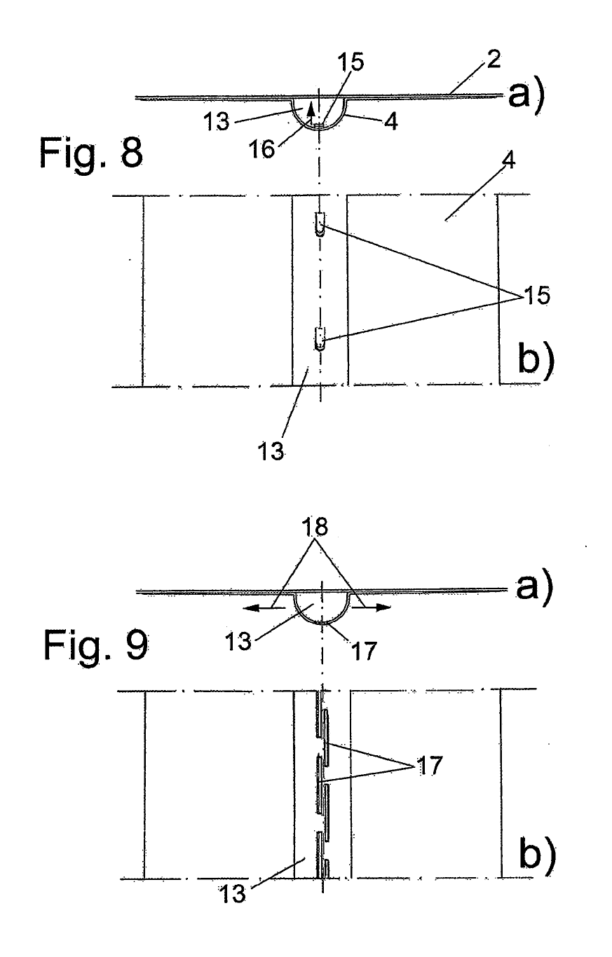

FIG. 8 shows punched tabs 15, which protrude into the channel 13 of the heat-conducting plate 4 and push the pipe (not illustrated here) below the absorber plate 2. The arrow 16 indicates the “direction of springing” of the tabs.

As an additional option, FIG. 9 shows punched recesses 17 in the channel 13 of the heat-conducting plate 4. The offset arrangement of the recesses 17 enables an improved expansion and contraction of the channel (indicated by the arrows 18) in order to compensate for varying expansion properties of the copper pipe and aluminum sheet. As a result, these components are enclosed in a manner that is optimum for heat conduction. They are constantly resting against each other. In spite of this constant contact, the copper pipe can “slide” (expand) in the longitudinal direction so that there are no visible signs of distortion on the surface of the absorber.

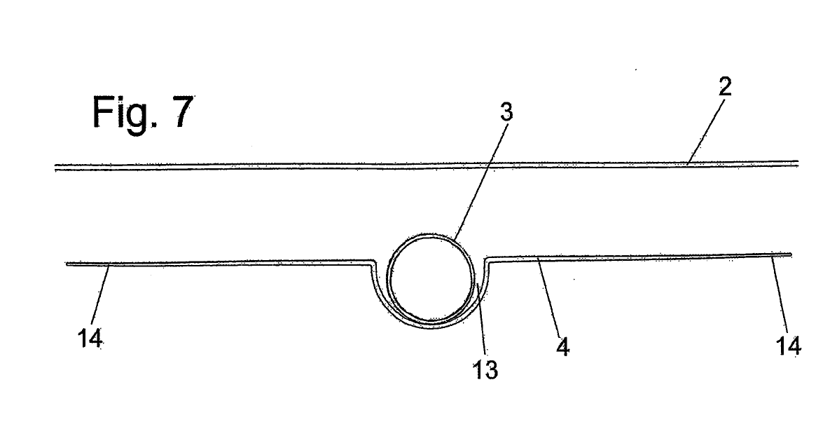

The individual process steps for manufacturing the absorber of the invention are explained with reference to FIG. 7. To begin with, the heat-conducting plates are produced from sheet metal that has been cut to size. The actual heat-conducting plate(s) is/are formed in advance from the sheet-metal blanks; that is to say, prior to or during the connection with the additional elements of the absorber. As the initial work piece, the sheet-metal blanks are preferably rolled in the form of strips. They can further be provided with a channel 13, or possibly with chambers and optionally also with tapered ends. The heat-conducting plates can also be merely cut to length in the form of flat strips and shaped only in the actual stamping process with the pipe and the absorber plate. The ends can naturally also be formed as air guide plates by cutting them at an angle, as is known from the prior art.

The channel 13, which is provided with an arcuate or semicircular shape, and the diameter of which is clearly larger than that of the pipe 3, is disposed at the center of the heat-conducting plate 4. The lateral arms of the heat-conducting plate 4 are then coated with an adhesive over their entire width or in part. The pipe 3, bent preferably in the form of a meander, is inserted into the channel 13 of the heat-conducting plate, which facilitates production due to the large lateral tolerances.

The pre-formed heat-conducting plate 4, the at least one pipe 3 and the absorber plate 2 are then layered on top of each other in this order, the absorber plate 2 lying on the pipes 3; that is to say, without coming into contact with the adhesive material on the heat-conducting plate 4.

The deformation of the pipe 3 and a gluing process take place in the subsequent pressing process. Here, the pipe 3 is deformed in such a way that it forms a flat contact surface toward the absorber plate 2 and completely fills out the channel 13 of the heat-conducting plate. Furthermore, the pipe ends preferably have a round and not a flattened cross-section in order to enable the mounting of standard connecting elements.

### TABLE OF REFERENCE SYMBOLS

1 Absorber
2 Absorber plate
3 Pipe
4 Heat-conducting plate
5 Pipe end
6 Pipe end
7 Surface
8 Surface
9 Metal strip
10 Chambers
11 Plate thickness
12 Plate thickness
13 Channel
14 Plate end

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An absorber, comprising:
an absorber plate having an at least partly or entirely flat surface;
at least one metallic pipe through which a heat transfer medium for carrying heat is flowable;
wherein the at least one metallic pipe has a partly flat surface operatively configured to rest against the at least partly or entirely flat surface of the absorber plate; and
at least one heat-conducting plate operatively arranged to secure the at least one metallic pipe on the at least partly or entirely flat surface of the absorber plate.

2. The absorber according to claim 1, further comprising an adhesive bond using an adhesive interconnecting the heat-conducting plate and the absorber plate, wherein no adhesive is provided between the absorber plate and the metallic pipe.

3. The absorber according to claim 2, further comprising heat-conducting substances admixed with the adhesive.

4. The absorber according to claim 3, further comprising one of metal strips and heat-conductive paste partly disposed between the heat-conducting plate and the absorber plate.

5. The absorber according to claim 2, further comprising one of metal strips and heat-conductive paste partly disposed between the heat-conducting plate and the absorber plate.

6. The absorber according to claim 1, wherein the heat-conducting plate includes portions in direct contact with the absorber plate and portions adhered to the absorber plate via an adhesive, the direct contact portions and adhered portions alternating with one another.

7. The absorber according to claim 1, wherein the heat-conducting plate has a thickness near the metallic pipe that tapers toward a reduced thickness away from the metallic pipe.

8. The absorber according to claim 7, wherein the absorber plate and the heat-conducting plate are made of one of aluminum and copper.

9. The absorber according to claim 1, wherein the at least one metallic pipe has a circular cross-sectional shape with a flattened region, the flattened region forming the partly flat surface that rests against the absorber plate, the flattened region extending over at least ⅓ of the pipe diameter; and
wherein the heat-conducting plate positively borders the remaining circular outer circumference of the metallic pipe.

10. The absorber according to claim 1, wherein the at least one metallic pipe has an oval cross-sectional shape, a circumference of which is partly flattened to form a flattened region that is the partly flat surface that rests against the absorber plate, the flat surface of the metallic pipe extending over at least ⅓ of the smaller pipe diameter of the oval; and
wherein the heat-conducting plate positively borders the remaining oval-shaped outer circumference of the metallic pipe.

11. The absorber according to claim 9, wherein the at least one metallic pipe has a meandering or serpentine shape comprising straight pipe sections and bent pipe sections; and
wherein one strip-shaped heat-conducting plate is assigned to each straight pipe section in a longitudinal direction, the bent pipe sections not being covered by a heat-conducting plate.

12. The absorber according to claim 9, wherein several metallic pipes are arranged substantially parallel to one another; and
wherein one strip-shaped heat-conducting plate is assigned to each straight pipe section.

13. The absorber according to claim 1, wherein the at least one heat-conducting plate includes one or more rolled chambers for receiving one of adhesives, heat-conductive pastes, and metal fibers.

14. The absorber according to claim 1, wherein the at least one metallic pipe has a wall thickness between 0.2 mm to 0.5 mm, and the at least one heat-conducting plate has a wall thickness of between 0.3 mm to 0.7 mm.

15. The absorber according to claim 1, wherein the at least one heat-conducting plate includes at least one channel in which the metallic pipe is disposed, the heat-conducting plate having punched tabs that protrude into the channel and being configured to press the metallic pipe toward the absorber plate.

16. The absorber according to claim 1, wherein the at least one heat-conducting plate includes at least one channel in which the metallic pipe is disposed, the heat-conducting plate having punched recesses formed in the channel.

17. A method for manufacturing an absorber having an absorber plate, at least one metallic pipe through which is flowable a heat transfer medium for carrying heat, and a heat-conducting plate, the method comprising the acts of:
combining the metallic pipe and the heat-conducting plate;
molding in a non-cutting work forming process a partly flat surface on the metallic pipe, the pipe being in direct contact with the absorber plate during at least a portion of the non-cutting work forming process.

18. The method according to claim 17, wherein the non-cutting work forming process is a pressing process, the metallic pipe, the heat-conducting plate, and the absorber plate being inserted together into a compression mold for the pressing process.

19. The method according to claim 17, wherein the combining act further comprises the acts of:
forming at least one channel in the heat-conducting plate;
inserting the metallic pipe into the one channel; and
further wherein the combined metallic pipe and heat-conducting plate are covered by the absorber plate and then subjected to the non-cutting work forming process, the channel having a diameter larger than that of the metallic pipe.

20. The method according to claim 19, wherein the heat-conducting plate is formed from a coil of strip-shaped sheet metal that is cut to a defined length, and wherein the channel is stamped into the sheet-metal.

21. The method according to claim 20, wherein several heat-conducting plates of the defined length are coated with an adhesive and inserted into a compression mold, metallic pipes being inserted into channels of the heat-conducting plates; and
wherein the absorber plate is placed on the metallic pipes and subsequently pressed onto the pipes using a smooth punch such that the metallic pipes expand in the channels of the heat-conducting plates during the non-cutting work forming process.

22. The method according to claim 21, wherein the channels of the heat-conducting plates and the diameter of the metallic pipes are configured to match one other such that the metallic pipes almost completely fills out an intermediate space remaining between the absorber plate and the heat-conducting plates after the non-cutting work forming process.
